(19) United States
(12) Patent Application Publication
(10) Pub. No.: US 2007/0275185 A1
(43) Pub. Date: Nov. 29, 2007

(54) METHOD OF MAKING ORDERED NANOSTRUCTURED LAYERS

(75) Inventors: Hassan SAHOUANI, Hastings, MN (US); Sanat Mohanty, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/419,880

(22) Filed: May 23, 2006

(51) Int. Cl. C09K 19/00

(52) U.S. Cl. 428/1.5; 428/1.3; 977/755; 977/712

(57) ABSTRACT

A method of making ordered nanostructured layers comprises (a) applying an aqueous composition comprising a chromonic material to the surface of a substrate, (b) applying shear orientation to the aqueous composition, (c) non-covalently crosslinking the resulting ordered nanostructured chromonic layer with a multivalent cation salt (d) exposing the resulting crosslinked ordered nanostructured chromonic layer to an acid selected from the group consisting of carbonic acid, phosphoric acid, lactic acid, citric acid, boric acid, sulfuric acid, and mixtures thereof in the presence of water to form an ordered nanostructured barrier layer.

### FIELD

This invention relates to methods of making ordered nanostructured layers and to structures comprising ordered nanostructured layers.

### BACKGROUND

The properties (for example, chemical, physical, electrical, optical, and magnetic properties) of materials depend, in part, on their atomic structure, microstructure, and grain boundaries or interfaces. Materials structured in the nanoscale range have therefore been attracting interest because of their unique properties as compared to conventional materials. As a result, there has been increasing research effort to develop nanostructured materials for a variety of technological applications such as, for example, electronic and optical devices, labeling of biological material, magnetic recording media, and quantum computing.

Numerous approaches have been developed for synthesizing/fabricating nanostructured materials. Approaches include, for example, using milling or shock deformation to mechanically deform solid precursors such as, for example, metal oxides or carbonates to produce a nanostructured powder (see, for example, Pardavi-Horvath et al., IEEE Trans. Magn., 28, 3186 (1992)), and using sol-gel processes to prepare nanostructured metal oxide or ceramic oxide powders and films (see, for example, U.S. Pat. No. 5,876,682 (Kurihara et al.), and Brinker et al., J. Non-Cryst. Solids, 147-148; 424-436 (1992)). It has proven difficult, however, to control the size and shape of the nanostructures, as well as their orientation and distribution, over a relatively large area using these approaches.

In order to addresses these difficulties, one approach for synthesizing/fabricating nanostructured materials that has been developed involves using chromonic materials. For example, an aqueous mixture of chromonic material and water-soluble polymer can be applied to a surface and allowed to dry. The water-soluble polymer can then be removed such that only a chromonic matrix remains on the substrate. The chromonic matrix can then be used as a mold to make surfaces such as, for example, surfaces comprising polymer posts in the nanometer to micrometer range.

### SUMMARY

Briefly, the present invention provides a method of making ordered nanostructured layers. The method comprises (a) applying an aqueous composition comprising a chromonic material to the surface of a substrate; (b) applying shear orientation to the aqueous composition either during or after application of the aqueous composition to the surface of the substrate, to form an ordered nanostructured chromonic layer; (c) non-covalently crosslinking the resulting ordered nanostructured chromonic layer with a multivalent cation salt; and (d) exposing the resulting crosslinked ordered nanostructured chromonic layer to an acid selected from the group consisting of carbonic acid, phosphoric acid, lactic acid, citric acid, boric acid, sulfuric acid, and mixtures thereof in the presence of water to form an ordered nanostructured barrier layer comprising a complex comprising the chromonic material, the multivalent cations, and the acid anions on the ordered nanostructured chromonic layer; wherein the acid is present in an amount that does not substantially dissolve the crosslinked ordered nanostructured chromonic layer. Surprisingly, it has been discovered that that the pattern of the ordered nanostructured chromonic layer is transferred to the barrier layer, and also to optional additional chromonic layers. It has also been discovered that the barrier layer is more stable (that is, the barrier is more resistant to physical and/or chemical erosion) than it would be if it were not formed on an ordered nanostructured chromonic layer As used herein, “chromonic materials” (or “chromonic compounds” or “chromonic molecules”) refers to large, multi-ring molecules typically characterized by the presence of a hydrophobic core surrounded by various hydrophilic groups (see, for example, Attwood, T. K., and Lydon, J. E., Molec. Crystals Liq. Crystals, 108, 349 (1984)). The hydrophobic core can contain aromatic and/or non-aromatic rings. When in solution, these chromonic materials tend to aggregate into a nematic ordering characterized by a long-range order.

In another aspect, the present invention provides a multilayered structure comprising (a) an ordered nanostructured crosslinked chromonic layer having a pitch between about 100 nm and about 20 μm, and (b) an ordered nanostructured barrier layer comprising a complex comprising chromonic material, multivalent cations, and acid anions selected from the group consisting of HCO₃⁻, PO₄³⁻, CH₃CHOHCOO⁻, C₃H₅O(COO)₃³⁻, BO₃³⁻, SO₄²⁻, and mixtures thereof disposed on at least a portion of the surface of the ordered nanostructured crosslinked chromonic layer.

In the multilayered structure of the invention, each layer contains chromonic molecules that are “ordered” or highly and regularly aligned to each other. For example, chromonic molecules can be “stacked” on top of each other such that the chromonic molecules in each stack are relatively evenly spaced from each other, and such that the stacks themselves are relatively evenly spaced from each other. The areas within the layer that have highly aligned stacks of chromonic molecules are referred to as “domains.” The regularity of the alignment of chromonic molecules within the layer also results in the alignment of larger features within the layers such as faults or cracks between the domains. The spacing between these faults or cracks is referred to as “pitch”. There can be more than one domain between faults or cracks.

The layers of the multilayered structures of the invention are “nanostructured” (that is, the dimensions of chromonic molecule stacks (for example, the spacing between the chromonic molecules, the spacing between the stacks, the height of the stacks, etc.) are typically in the nanometer scale (preferably, between about 1 nm and about 100 nm). The size of the domains and the pitch are typically between about 100 nm and about 20 μm.

### BRIEF DESCRIPTION OF DRAWINGS

FIG. 1 is an optical microscope image of a chromonic layer at 100× magnification as described in Comparative Example 1.

FIG. 2 is an optical microscope image of an ordered nanostructured chromonic layer and barrier layer at 100× magnification as described in Example 1.

FIG. 3 is an optical microscope image of a second ordered nanostructured chromonic layer at 100× magnification as described in Example 3.

### DETAILED DESCRIPTION

Any chromonic material can be useful in the methods and structures of the invention. Compounds that form chromonic phases are known in the art, and include, for example, xanthoses (for example, azo dyes and cyanine dyes) and perylenes (see, for example, Kawasaki et al., Langmuir 16, 5409 (2000), or Lydon, J., Colloid and Interface Science, 8, 480 (2004). Representative examples of useful chromonic materials include di- and mono-palladium organyls, sulfamoyl-substituted copper phthalocyanines, and hexaaryltryphenylene.

Preferred chromonic materials include those selected from one or more of the following general formulae:

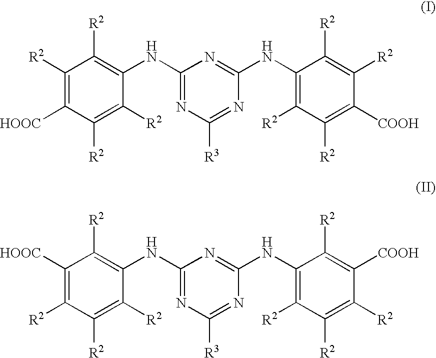

wherein
each R² is independently selected from the group consisting of electron donating groups, electron withdrawing groups, and electron neutral groups, and
R³ is selected from the group consisting of a substituted and unsubstituted heteroaromatic ring, and a substituted and unsubstituted heterocyclic ring, the ring being linked to the triazine group through a nitrogen atom within the ring of R³.

A counterion is present when required to balance the charge.

As depicted above, the chromonic compound is neutral, but it can exist in alternative forms such as a zwitterion or proton tautomer (for example, where a hydrogen atom is dissociated from one of the carboxyl groups and is associated with one of the nitrogen atoms in the triazine ring). The chromonic compound can also be a salt such as, for example, a carboxylate salt.

The general structures above show orientations in which the carboxyl group is para with respect to the amino linkage to the triazine backbone of the compound (formula I) and in which the carboxyl group is meta with respect to the amino linkage to the triazine backbone (formula II). The carboxyl group can also be a combination of para and meta orientations (not shown). Preferably, the orientation is para.

Preferably, each R² is hydrogen or a substituted or unsubstituted alkyl group. More preferably, R² is independently selected from the group consisting of hydrogen, unsubstituted alkyl groups, alkyl groups substituted with a hydroxy or halide functional group, and alkyl groups comprising an ether, ester, or sulfonyl. Most preferably, R² is hydrogen.

R³ can be, but is not limited to, a heteroaromatic ring derived from pyridine, pyridazine, pyrimidine, pyrazine, imidazole, oxazole, isoxazole thiazole, oxadiazole, thiadiazole, pyrazole, triazole, triazine, quinoline, and isoquinoline. Preferably, R³ comprises a heteroaromatic ring derived from pyridine or imidazole. A substituent for the heteroaromatic ring R³ can be selected from, but is not limited to, the group consisting of substituted and unsubstituted alkyl, carboxy, amino, alkoxy, thio, cyano, amide, sulfonyl, hydroxy, halide, perfluoroalkyl, aryl, ether, and ester groups. Preferably, the substituent for R³ is selected from the group consisting of alkyl, sulfonyl, carboxy, halide, perfluoroalkyl, aryl, ether, and alkyl substituted with hydroxy, sulfonyl, carboxy, halide, perfluoroalkyl, aryl, or ether. When R³ is a substituted pyridine, the substituent is preferably located at the 4-position. When R³ is a substituted imidazole, the substituent is preferably located at the 3-position.

Representative examples of R³ include 4-(dimethylamino)pyridinium-1-yl, 3-methylimidazolium-1-yl, 4-(pyrrolidin-1-yl)pyridinium-1-yl, 4-isopropylpyridinium-1-yl, 4-[(2-hydroxyethyl)methylamino]pyridinium-1-yl, 4-(3-hydroxypropyl)pyridinium-1-yl, 4-methylpyridinium-1-yl, quinolinium-1-yl, 4-tert-butylpyridinium-1-yl, and 4-(2-sulfoethyl)pyridinium-1-yl, shown below.

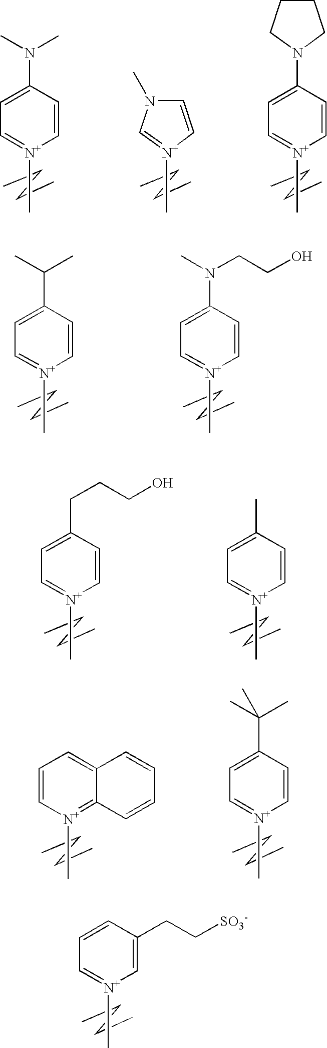

R³ can also be represented by the following general structure:

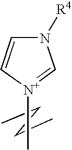

wherein R⁴ is hydrogen or a substituted or unsubstituted alkyl group. More preferably, R⁴ is selected from the group consisting of hydrogen, unsubstituted alkyl groups, and alkyl groups substituted with a hydroxy, ether, ester, sulfonate, or halide functional group. Most preferably R⁴ is selected from the group consisting of propyl sulfonic acid, methyl, and oleyl.

R³ can also be selected from heterocyclic rings such as, for example, morpholine, pyrrolidine, piperidine, and piperazine.

A preferred chromonic compound for use in the invention can be represented by one of the following formulae:

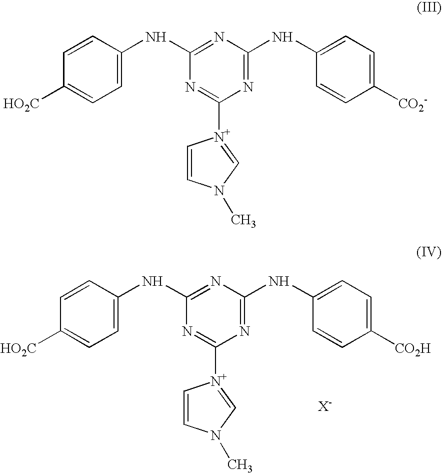

wherein X⁻ is a counterion. Preferably, X⁻ is selected from the group consisting of HSO₄⁻, Cl⁻, CH₃COO⁻, and CF₃COO⁻.

Formula III depicts the compound in its zwitterionic form. The imidazole nitrogen therefore carries a positive charge and one of the carboxy functional groups carries a negative charge (COO⁻).

The compound can also exist in other tautomeric forms such as where both carboxy functional groups carry a negative charge and where positive charges are carried by one of the nitrogens in the triazine groups and the nitrogen on the imidazole group.

An example of another preferred zwitterionic chromonic molecule, 4-({4-[(4-carboxylphenyl)amino]-6-[4-(dimethylamino)pyridinium-1-yl]-1,3,5-triazin-2-yl}amino)benzoate, is shown in Formula V below where R³ is a dimethylamino substituted pyridine ring linked to the triazine group through the nitrogen atom of the pyridine ring. As shown, the pyridine nitrogen carries a positive charge and one of the carboxy functional groups carries a negative charge (and has a dissociated cation, such as a hydrogen atom), —COO⁻.

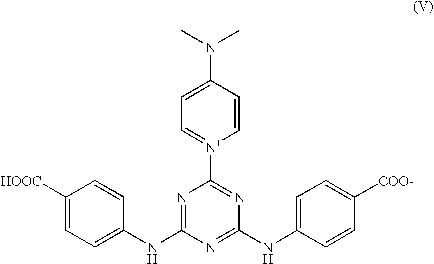

The chromonic molecule shown in Formula V may also exist in other tautomeric forms, such as where both carboxy functional groups carry a negative charge and where positive charges are carried by one of the nitrogen atoms in the triazine group and the nitrogen on the pyridine group.

As described in U.S. Pat. No. 5,948,487 (Sahouani et al.), which is herein incorporated by reference in its entirety, triazine derivatives with formula I can be prepared as aqueous solutions. A typical synthetic route for the triazine molecules shown in formula I above involves a two-step process. Cyanuric chloride is treated with 4-aminobenzoic acid to give 4-{[4-(4-carboxyanilino)-6-chloro-1,3,5-triazin-2-yl]amino}benzoic acid. This intermediate is treated with a substituted or unsubstituted nitrogen-containing heterocycle. The nitrogen atom of the heterocycle displaces the chlorine atom on the triazine to form the corresponding chloride salt. The zwitterionic derivative, such as that shown in formula III above, is prepared by dissolving the chloride salt in ammonium hydroxide and passing it down an anion exchange column to replace the chloride with hydroxide, followed by solvent removal. Alternative structures, such as that shown in formula II above, may be obtained by using 3-aminobenzoic acid instead of 4-aminobenzoic acid.

Chromonic materials are capable of forming a chromonic phase or assembly when dissolved in an aqueous solution (preferably, an alkaline aqueous solution). Chromonic phases or assemblies are well known in the art (see, for example, Handbook of Liquid Crystals, Volume 2B, Chapter XVIII, Chromonics, John Lydon, pp. 981-1007, 1998) and consist of stacks of flat, multi-ring aromatic molecules. The molecules consist of a hydrophobic core surrounded by hydrophilic groups. The stacking can take on a number of morphologies, but is typically characterized by a tendency to form columns created by a stack of layers. Ordered stacks of molecules are formed that grow with increasing concentration.

Preferably, the chromonic material is placed in aqueous solution in the presence of one or more pH-adjusting compounds and optionally a surfactant. The addition of pH-adjusting compounds allows the chromonic material to become more soluble in aqueous solution. Suitable pH-adjusting compounds include any known base such as, for example, ammonium hydroxide, potassium hydroxide, lithium hydroxide, sodium carbonate or bicarbonate, potassium carbonate or bicarbonate, lithium carbonate or bicarbonate, potassium borate, sodium borate, lithium borate, or various amines. Surfactant can be added to the aqueous solution, for example, to promote incorporation of a drug into the chromonic matrix of the chromonic nanoparticle. As used herein, “chromonic matrix” refers to chromonic materials that are aggregated into a nematic ordering.

Suitable surfactants include ionic and non-ionic surfactants (preferably, non-ionic). Optional additives such as viscosity modifiers (for example, polyethylene glycol) and/or binders (for example, low molecular weight hydrolyzed starches) can also be added.

Typically, the chromonic materials are dissolved in the aqueous solution at a temperature less than about 40° C. (more typically, at room temperature), and neutralized to pH 6-8 by the addition of a base. One skilled in the art will recognize, however, that the geometry and size of the resulting nanostructures can be controlled to some extent by varying the temperature.

The relative concentrations of each of the components in the aqueous solution will vary with the desired orientation of the resulting nanostructures and their intended application. Generally, however, the chromonic material will be added to the solution to achieve a concentration in the range of about 5 to about 40 (preferably, about 5 to about 20) percent by weight of the solution.

The aqueous composition comprising a chromonic material can be applied to the surface of a substrate. Suitable substrates include any solid materials that will accept the application of the mixture (for example, glass or polymeric films).

The mixture can be applied by any useful means that provides for the ordered arrangement of the chromonic materials such as, for example, by coating techniques such as wirewound coating rod or extrusion die methods. Shear orientation (that is, a force such as a “sliding” force applied parallel to the plane of the substrate) is applied to the mixture either during or after application. The application of shear to the mixture can help promote alignment of the chromonic materials such that, upon drying, an oriented structure or matrix is obtained. Generally, the ordered nanostructured chromonic layer will have a pitch between 100 nm and about 20 μm (preferably, between about 300 nm and about 5 μm).

Drying of the coated layer can be achieved using any means suitable for drying aqueous coatings. Useful drying methods will not damage the coating or significantly disrupt the orientation of the coated layer imparted during coating or application.

Optionally, surfactants and other additives (for example, short chain alcohols such as ethanol) that decrease surface tension or promote coating can be added.

The resulting ordered nanostructured chromonic layer is non-covalently crosslinked by multivalent cations. This crosslinking makes the chromonic layer insoluble in water. By non-covalent, it is meant that the crosslinking does not involve permanently formed covalent (or chemical) bonds. That is, the crosslinking does not result from a chemical reaction that leads to a new, larger molecule, but rather results from electrostatic and/or coordination associations of the cations with the host molecules that are strong enough to hold them together without undergoing a chemical reaction. These interactions are typically ionic in nature and can result from interaction of a formal negative charge on the host molecule with the formal positive charge of a multivalent cation. Since the multivalent cation has at least two positive charges, it is able to form an ionic bond with two or more chromonic molecules, that is, a crosslink between two or more chromonic molecules. Divalent and/or trivalent cations are preferred. Suitable cations include any divalent or trivalent cations, with barium, calcium, magnesium, zinc, aluminum, and iron being particularly preferred.

In some embodiments, the aqueous composition can be mixed with a noble metal salt in solution to produce an ordered metallic chromonic layer. Subsequently, the mixture can be brought into contact with a polyvalent cation salt to non-covalently crosslink the chromonic material and incorporate the noble metal salt.

Preferred noble metal salts include silver salts (for example, silver nitrate, silver acetate, and the like), gold salts (for example, gold sodium thiomalate, gold chloride, and the like), platinum salts (for example, platinum nitrate, platinum chloride, and the like), and mixtures thereof. Other transition metals can also be used. In particular, salts of monovalent transition metal cations can be used.

The metal salt can be reduced to produce a suspension of elemental noble metal nanoparticles contained in the crosslinked chromonic layer. This can be accomplished via reduction methods known in the art. For example, the reduction can be accomplished by using a reducing agent (for example, tris(dimethylamino)borane, sodium borohydride, potassium borohydride, or ammonium borohydride), electron beam (e-beam) processing, or ultraviolet (UV) light.

The metal nanoparticles can, for example, serve as a tag. They can be useful in numerous applications such as medical imaging, optical switching devices, optical communication systems, infrared detectors, infrared cloaking devices, chemical sensors, passive solar radiation collection or deflecting devices and the like.

Ordered crosslinked chromonic layers can be exposed to an acid in the presence of water to form an ordered nanostructured barrier layer comprising a complex comprising chromonic material, multivalent cations (from the multivalent cation salt), and acid anions. Suitable acids include carbonic acid, phosphoric acid, lactic acid, citric acid, boric acid, sulfuric acid, and mixtures thereof. Preferred acids are carbonic acid and phosphoric acid.

The acid is present in an amount such that the crosslinked chromonic layer does not substantially dissolve (for example, in amount such that no more than about 25 weight percent (preferably, no more than about 10 weight percent) of the chromonic layer dissolves in a 2 hour period. When the acid is phosphoric acid, for example, the weight ratio of 1N phosphoric acid:water is typically between about 1:10 and about 1:300 (preferably, between about 1:25 and about 1:100; more preferably, about 1:50).

The crosslinked chromonic layer can be exposed to the acid in the presence of water in numerous ways. For example, a substrate comprising the crosslinked chromonic layer can be dipped in a dilute acid solution. When the acid to be utilized is carbonic acid, a substrate comprising the crosslinked chromonic layer can be placed in a sealed container with dry ice, or in a vessel containing an aqueous composition through which carbon dioxide (from dry ice) can be bubbled.

The resulting barrier layer has the same ordered pattern of the ordered nanostructured chromonic layer on which it is formed. The pitch of the resulting barrier layer can be the same of different than the pitch of the ordered nanostructured chromonic layer depending on, for example, the thickness of the coating, the concentration of the chromonic layer, and the use of additives. Surprisingly, the ordered nanostructured barrier layer is more stable than a similar complexed layer that is not ordered. For example, the ordered nanostructured barrier layer is more stable than a complexed layer comprising chromonic material, multivalent cations, and acid anions that was formed on an unordered chromonic layer (for example, a chromonic layer that was coated without applying shear orientation).

Optionally, the surface of the ordered nanostructured chromonic layer (subsequent to non-covalent crosslinking) or the surface of the ordered nanostructured barrier layer can be modified with a surface-modifying agent to render the surface more hydrophilic, hydrophobic, biocompatible, or bioactive, or to modify the layer's electrical or optical properties. The surface groups preferably are present in an amount sufficient to form a monolayer, preferably a continuous monolayer.

Surface modifying groups may be derived from surface modifying agents. Schematically, surface modifying agents can be represented by the formula A-B, where the A group is capable of attaching to the surface of the chromonic nanoparticle and the B group is a compatibilizing group that confers the desired hydrophilicity, hydrophobicity or biocompatibility. Compatibilizing groups can be selected to render the particle relatively more polar, relatively less polar or relatively non-polar.

Suitable classes of surface-modifying agents include organic oxyacids of carbon, sulfur and phosphorus, for example, alkylcarboxylates, alkyl sulfates, alkylsulfonates, alkyl phosphates and alkylphosphonates, glycoside phosphonates, and combinations thereof. The surface-modifying agents available under the trade names Tweens™ and Spans™ can also be useful.

Representative examples of polar surface-modifying agents having carboxylic acid functionality include poly(ethylene glycol) monocarboxylic acid having the chemical structure CH₃O(CH₂CH₂O)ₙCH₂COOH (n=2-50) and 2-(2-methoxyethoxy)acetic acid having the chemical structure CH₃OCH₂CH₂OCH₂COOH in either acid or salt forms.

Representative examples of non-polar surface-modifying agents having carboxylic acid functionality include octanoic acid, dodecanoic acid and oleic acid in either acid or salt form. In the case of a carboxylic acid containing olefinic unsaturation, such as oleic acid, the carbon-carbon double bonds may be present as either the Z or E stereoisomers or as a mixture thereof.

Examples of suitable phosphorus containing acids include alkylphosphonic acids including, for example, octylphosphonic acid, decylphosphonic acid, dodecylphosphonic acid, octadecylphosphonic acid, oleylphosphonic acid and poly(ethylene glycol) monophosphonic acid having the chemical structure CH₃O(CH₂CH₂O)ₙCH₂CH₂PO₃H₂ (n=2-50) in either acid or salt forms. In the case of a phosphonic acid containing olefinic unsaturation, such as oleylphosphonic acid, the carbon-carbon double bonds may be present as either the Z or E stereoisomers or as a mixture thereof.

Additional examples of suitable phosphorus containing acids include alkyl phosphates such as mono- and diesters of phosphoric acid including, for example, octyl phosphate, dodecyl phosphate, oleyl phosphate, dioleyl phosphate, oleyl methyl phosphate and poly(ethylene glycol) monophosphoric acid having the chemical structure CH₃O(CH₂CH₂O)ₙCH₂CH₂OPO₃H₂ (n=2-50).

In some modifications, the B group of the surface modifying agent A-B can also contain an additional specific functional group(s) to further adjust the hydrophilicity, hydrophobicity or biocompatibility of the layer. Suitable functional groups include, but are not limited to the hydroxyl, carbonyl, ester, amide, ether, amino, and quaternary ammonium functions.

Other suitable surface modifying agents are surfactants of polymeric nature.

If biocompatibility is desired, the layer may be surface modified with glycosides phosphonates, for example, glucosides, mannosides, and galactosides of phosphonic acid.

If modification of electrical properties is desired, the layer may be surface modified with conjugated double bonds and/or aromatic rings.

If modification of optical properties is desired, the layer may be surface modified with organic or inorganic molecules or surface modified nanoparticles that have a different refractive index.

Optionally, additional chromonic layers can be formed on the barrier layer. For example, a second aqueous composition comprising a chromonic material can be prepared as described above and applied on to at least a portion of the ordered nanostructured barrier layer to form a second ordered nanostructured chromonic layer. Any of the chromonic materials described above can be used in the second aqueous composition comprising a chromonic material. The chromonic material used in the second aqueous composition comprising a chromonic material can be the same chromonic material or a different chromonic material than that utilized in the first aqueous mixture. For example, in some applications it can be advantageous to use two different chromonic materials that have different absorbencies or different stabilities in low pH conditions.

Generally, for the second aqueous composition comprising a chromonic material, the chromonic material will be added to the solution to achieve a concentration in the range of about 1 to about 25 (preferably, about 1 to about 15) percent by weight of the solution. Optionally, pH-adjusting compounds, surfactants, and/or noble metal salts can be utilized as described above.

Surprisingly, shear orientation does not need to be applied to the second aqueous composition in order for the second chromonic layer to have an ordered nanostructure. The pattern of the first ordered nanostructured layer is transferred to the barrier layer and to the second chromonic layer.

Optionally, the second ordered nanostructured chromonic layer can be non-covalently crosslinked with a multivalent cation salt as described above. Whether the second ordered nanostructured chromonic layer is crosslinked will depend upon the intended application for the resulting multilayered structure. Typically, the second ordered nanostructured chromonic layer will be crosslinked if a third chromonic layer is to be added on top of the second chromonic layer.

Subsequent to non-covalent crosslinking, the second chromonic layer can be contacted with a surface-modifying agent, as described above, to render the shell layer of chromonic material around the chromonic nanoparticle more hydrophilic, hydrophobic, biocompatible, or bioactive.

A third ordered nanostructured chromonic layer can be formed on the second chromonic layer by applying a third aqueous composition comprising a chromonic material onto at least a portion of the second nanostructured chromonic layer. The pattern of the first ordered nanostructured layer is also transferred to this third chromonic layer. The third chromonic layer can also optionally be non-covalently crosslinked.

When additional chromonic layers have been added, the outermost chromonic layer can optionally be exposed to an organic solvent if it has not been crosslinked in order to magnify the ordered nanostructured pattern of the layer. Typically, the organic solvent will be applied dropwise to the dried chromonic layer. Suitable organic solvents include, for example, alcohols such ethanol, 1-propanol, 1-butanol, 2-butanol, tertiary butanol, and the like (preferably, ethanol); and ketones such as acetone, methyl ethyl ketone, cyclopentanone, cyclohexanone, and the like. Other useful organic solvents include, for example, acetonitrile, tetrahydrofuran, methyl tertiary butyl ether, dimethyl carbonate, and diethyl carbonate. The organic solvent causes ordered cracks to form on the surface of the layer.

The resulting multilayered structures comprise an ordered nanostructured crosslinked chromonic layer, which typically has a pitch between about 100 nm and about 20 μm (preferably, between about 300 nm and about 5 μm), and an ordered nanostructured barrier layer comprising a complex comprising chromonic material, multivalent cations, and acid anions selected from the group consisting of HCO₃⁻, PO₄³⁻, CH₃CHOHCOO⁻, C₃H₅O(COO)₃³⁻, BO₃³⁻, SO₄²⁻, and mixtures thereof. The barrier layer will also typically have a pitch between about 100 nm and about 20 μm. The pitch of the barrier layer may be the same or different than that of the ordered nanostructured chromonic layer.

Typically, the combined thickness of the ordered nanostructured crosslinked chromonic layer and the barrier layer will be between about 0.5 μm and about 5 μm (preferably, between about 0.8 μm and about 1.5 μm). The barrier layer typically comprises about 1 to 5 monolayers.

The multilayered structure can further comprise additional ordered nanostructured layers on at least a portion of the barrier layer.

The multilayered structures of the invention can be useful in numerous applications such as, for example, in drug delivery patches, microfluidic devices, as stable, impermeable coatings (for example, to protect biomolecules from acidic conditions), and in long-range, highly ordered nanodevices for electronic applications.

The complexed barrier layer can be useful, for example, in sorption applications (for example, to absorb certain proteins, cations, small molecule drugs or catalysts). The present invention can also be used for the controlled release of one or more guest compounds. Guest compounds can be encapsulated within any of the ordered nanostructured chromonic layers.

For example, the complexed barrier layer can effectively isolate guest molecules that are unstable in the presence of an acid. Thus, they will not degrade while encapsulated under the complexed barrier layer.

Examples of useful guest compounds include dyes, cosmetic agents, fragrances, flavoring agents, and bioactive compounds, such as drugs, herbicides, pesticides, pheromones, and antimicrobial agents (for example, antibacterial agents, antifungal agents, and the like). A bioactive compound is herein defined as a compound intended for use in the diagnosis, cure, mitigation, treatment or prevention of disease, or to affect the structure or function of a living organism. Drugs (that is, pharmaceutically active ingredients) that are intended to have a therapeutic effect on an organism are particularly useful guest compounds. Alternatively, herbicides and pesticides are examples of bioactive compounds intended to have a negative effect on a living organism, such as a plant or pest. Although any type of drug can be employed in the present invention, particularly suitable drugs include those that are relatively unstable when formulated as solid dosage forms, those that are adversely affected by the low pH conditions of the stomach, those that are adversely affected by exposure to enzymes in the gastrointestinal tract, and those that are desirable to provide to a patient via sustained or controlled release.

The complexed barrier layer and the chromonic layer(s) will selectively protect a drug from certain environmental conditions and then controllably deliver the drug under other environmental conditions. For example, the complexed barrier layer can be stable in the acidic environment of the stomach and will dissolve when passed into the non-acidic environment of the intestine when administered to an animal as a result of the change in pH. Chromonic materials can also protect a drug from enzymatic degradation.

Guest compounds can be contained or intercalated in chromonic layers by adding guest compounds to the first aqueous composition comprising a chromonic material. Alternatively, a guest compound can be dispersed or dissolved in another excipient or vehicle, such as an oil or propellant, prior to mixing with the chromonic materials or multivalent cation solutions.

A guest compound, such as a drug, can be dissolved in an aqueous dispersant-containing solution prior to introduction of the chromonic material. Suitable dispersants include alkyl phosphates, phosphonates, sulfonates, sulfates, or carboxylates, including long chain saturated fatty acids or alcohols and mono or poly-unsaturated fatty acids or alcohols. Oleyl phosphonic acid is an example of a suitable dispersant. Although not to be bound by any particular theory, it is thought that the dispersant aids in dispersing the guest compound so that it may be better encapsulated.

An alkaline compound can be added to the guest compound solution prior to introduction of the chromonic material. Alternatively, an alkaline compound can be added to a chromonic material solution prior to mixing the guest compound and chromonic material solutions. Examples of suitable alkaline compounds include ethanolamine, sodium or lithium hydroxide, or amines such as mono, di, triamines or polyamines. Although not to be bound by theory, it is thought that alkaline compounds aid in dissolving the host compound, particularly where the host compound is a triazine compound such as those described in formulas I and II above.

Guest compounds can be contained or intercalated in an optional chromonic layer (for example, the second ordered nanostructured chromonic layer) by adding guest compounds to the second aqueous composition comprising a chromonic material or the multivalent cation solution prior to precipitation. As described above, a guest compound can be dispersed or dissolved in another excipient or vehicle, such as an oil or propellant, prior to mixing with the chromonic materials or multivalent cation solutions.

Chromonic layers are dissolvable in an aqueous solution of univalent cations or other non-ionic compounds such as surfactants. Typical univalent cations include sodium and potassium. The concentration of univalent cations needed to dissolve the chromonic layers will depend on the type and amount of the chromonic molecules within the layers. Therefore, different chromonic materials can be chosen for the different ordered nanostructured chromonic layers so that they dissolve at different concentrations. Generally, however, for complete dissolution there should be at least a molar amount of univalent cations equivalent to the molar amount of carboxyl groups in the matrix. In this way, there will be at least one univalent cation to associate with each carboxyl group. The complexed barrier layer of the present invention, however, exhibits increased resistance to aqueous solutions of univalent cations and other non-ionic compounds as compared to the chromonic layers.

### EXAMPLES

Objects and advantages of this invention are further illustrated by the following examples, but the particular materials and amounts thereof recited in these examples, as well as other conditions and details, should not be construed to unduly limit this invention.

Unless otherwise noted, all reagents and compounds were or can be obtained from Sigma-Aldrich Chemical Co., St. Louis, Mo. As used herein, “purified water” refers to water available under the trade designation “OMNISOLVE” from EMD Chemicals, Inc., Gibbstown, N.J.

The optical microscope used was a Model UCT with FC6 cyro attachment available from Leica Microsystems, Inc., Bannockburn, Ill.). Drawdown bars (wire size 2.5) were supplied by UV Process Supplies of Chicago, Ill.

### Preparation of the Chromonic Mixture (“Chromonic Mixture”)

A mixture containing the chromonic compound of Formula V (percent by weight as indicated in examples below) in purified water was magnetically stirred in a flask for approximately 45 minutes to make a white paste. A freshly prepared solution of Sodium hydroxide (50% by weight in purified water) was added drop wise to the flask containing the white paste until its appearance changed to a creamy liquid crystalline solution. The pH of this mixture was maintained to be at or less than 7.5 during this addition process by controlling the addition of sodium hydroxide solution. The resulting creamy liquid crystalline solution (the “chromonic mixture”) was used as needed.

### Preparation of Phosphate Buffer Saline Solution (PBS)

This solution was made by mixing stock solution A (200 ml) with stock solution B (60 ml) for 15 min using a magnetic stirrer and adjusting pH to 7.5 using stock solution B as needed. Stock solution A contained disodium hydrogen phosphate (1 g) and sodium chloride (1.7 g) in purified water (200 ml). Stock solution B contained disodium hydrogen phosphate (0.56 g) and sodium chloride (1.7 g) in purified water (200 ml).

### Comparative Example 1

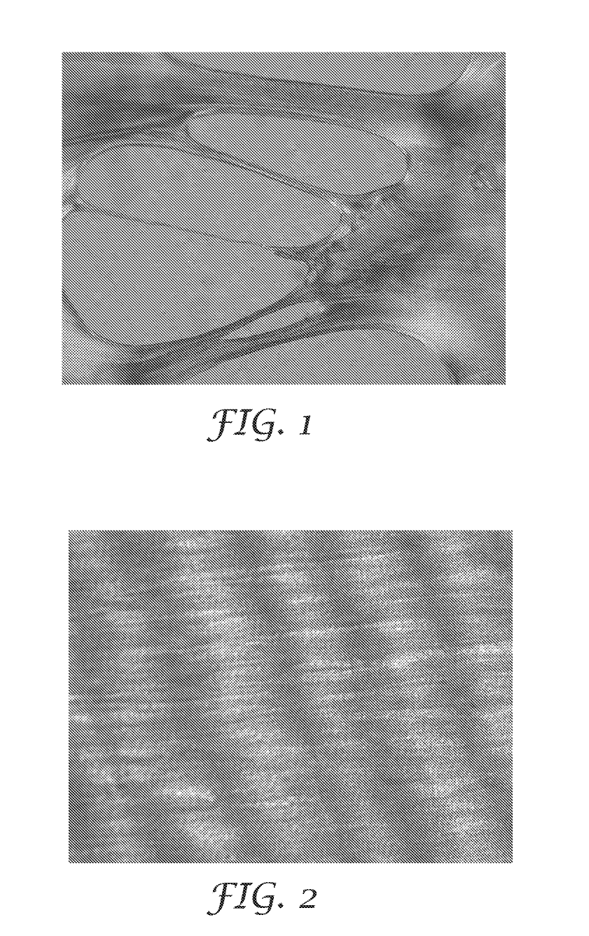

A 10% solution of the chromonic mixture prepared as described was coated on to a glass slide (2 by 5 cm) by dipping the slide into the container with the solution and keeping it in for 30 seconds before it was quickly pulled out. A layer of chromonic mixture had formed on the glass, but no specific order was seen when observed under the microscope at a 100× magnification (FIG. 1).

### Comparative Example 2

A 20% solution of the chromonic mixture prepared as described was coated on to a glass slide (2 by 5 cm) using the drawdown bar to form a layer. Long range order was seen in the layer when observed under the microscope at a 100× magnification. This coated slide with the layer of chromonic mixture was then dipped into an aqueous solution of zinc chloride and calcium chloride (5% each). After 10 minutes, the slide was rinsed by dipping into a beaker containing purified water. It was then dipped into the PBS solution. After about 20 minutes, presence of particles was observed in the buffer solution indicating that the coating had begun to erode in the presence of the buffer solution.

### Example 1

A 10% solution of the chromonic mixture prepared as described was coated on to a glass slide (2 by 5 cm) using the drawdown bar to form a layer. This coated slide with the layer of chromonic mixture was then dipped into an aqueous solution of zinc chloride and calcium chloride (5% each). After 10 minutes, the slide was removed and rinsed by dipping into a beaker containing purified water. After the rinsing step, this slide with the layer of chromonic mixture was kept dipped into an aqueous solution of phosphoric acid (1%) for 1 minute. The slide was then rinsed by dipping into a beaker containing purified water. A layer of chromonic mixture and a barrier had formed on the glass and a long range order was seen when observed under the microscope at a 100× magnification (FIG. 2). This coated layer was birefringent.

### Example 2

A 20% solution of the chromonic mixture prepared as described was coated on to a glass slide (2 by 5 cm) using a drawdown bar to form a layer. This coated slide with the layer of chromonic mixture was then dipped into an aqueous solution of zinc chloride and calcium chloride (5% each). After 10 minutes, the slide was removed and rinsed by dipping into a beaker containing purified water. After the rinsing step, this slide with the layer of chromonic mixture was kept dipped into an aqueous solution of phosphoric acid (1%) for 1 minute. The slide was then rinsed by dipping into a beaker containing purified water. A layer of chromonic mixture and a barrier had formed on the glass and a long range order was seen when observed under the microscope at a 100× magnification. The slide was then dipped into the PBS solution. After about one hour, presence of particles was observed in the buffer solution indicating that the coating had begun to erode in the presence of the buffer solution.

### Example 3

A 20% solution of the chromonic mixture prepared as described was coated on to a glass slide (2 by 5 cm) using a drawdown bar. A layer of chromonic mixture had formed on the glass, and a long range order was seen when observed under the microscope at a 100× magnification. This coated layer was also birefringent.

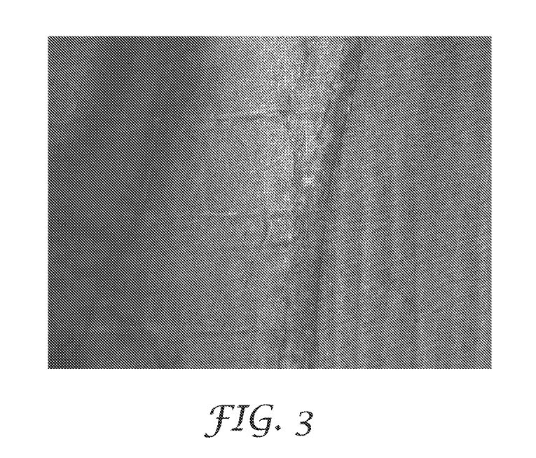

This coated slide with the layer of chromonic mixture was then dipped into an aqueous solution of zinc chloride (10%). After 10 minutes, the slide was removed and rinsed by dipping into a beaker containing purified water. After the rinsing step, this slide was kept dipped into an aqueous solution of phosphoric acid (1%) for 1 minute. The slide was then rinsed by dipping into a beaker containing purified water. One half of the coated area of this glass slide was then dipped into a 10% solution of the chromonic mixture for 30 seconds before the slide was quickly pulled out. When observed under the microscope at a 100× magnification, the second chromonic layer also showed an orderly structure (FIG. 3).

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

We claim:

1. A method of making ordered nanostructured layers comprising:
(a) applying an aqueous composition comprising a chromonic material to the surface of a substrate;
(b) applying shear orientation to the aqueous composition either during or after application of the aqueous composition to the surface of the substrate, to form an ordered nanostructured chromonic layer;
(c) non-covalently crosslinking the resulting ordered nanostructured chromonic layer with a multivalent cation salt; and
(d) exposing the resulting crosslinked ordered nanostructured chromonic layer to an acid selected from the group consisting of carbonic acid, phosphoric acid, lactic acid, citric acid, boric acid, sulfuric acid, and mixtures thereof in the presence of water to form an ordered nanostructured barrier layer comprising a complex comprising the chromonic material, the multivalent cations, and the acid anions on the ordered nanostructured chromonic layer; wherein the acid is present in an amount that does not substantially dissolve the crosslinked ordered nanostructured chromonic layer.

2. The method of claim 1 wherein the aqueous composition comprises from about 5 to about 40 weight percent chromonic material.

3. The method of claim 1 wherein the aqueous composition comprising a chromonic material further comprises a guest compound.

4. The method of claim 1 further comprising applying a second aqueous composition comprising a chromonic material on to at least a portion of the ordered nanostructured barrier layer to form a second ordered nanostructured chromonic layer.

5. The method of claim 4 wherein the second aqueous composition comprises from about 1 to about 25 weight percent chromonic material.

6. The method of claim 4 wherein the second aqueous composition comprising a chromonic material further comprises a guest compound.

7. The method of claim 4 further comprising exposing the second ordered nanostructured layer to an organic solvent.

8. The method of claim 7 wherein the organic solvent is ethanol.

9. The method of claim 4 further comprising non-covalently crosslinking the second ordered nanostructured chromonic layer with a multivalent cation salt.

10. The method of claim 9 further comprising applying a third aqueous composition comprising a chromonic material on to at least a portion of the second ordered nanostructured chromonic layer to form a third ordered nanostructured chromonic layer.

11. The method of claim 1 wherein the acid is present in an amount such that no more than about 25 weight percent of the crosslinked nanostructured chromonic layer dissolves in a 2-hour period.

12. The method of claim 11 wherein the acid is present in an amount such that no more than about 10 weight percent of the crosslinked nanostructured chromonic layer dissolves in a 2-hour period.

13. The method of claim 1 wherein the crosslinked ordered nanostructured chromonic layer is exposed to carbonic acid.

14. The method of claim 1 wherein the crosslinked ordered nanostructured chromonic layer is exposed to phosphoric acid.

15. The method of claim 1 wherein the multivalent cation of the multivalent cation salt is selected from the group consisting of Ba²⁺, Ca²⁺, Fe²⁺, Fe³⁺, Zn²⁺, Mg²⁺, and Al³⁺.

16. The method of claim 15 wherein the multivalent cation of the multivalent cation salt is Ca²⁺.

17. The method of claim 1 wherein the chromonic material is selected from one or more of the following general formulae: 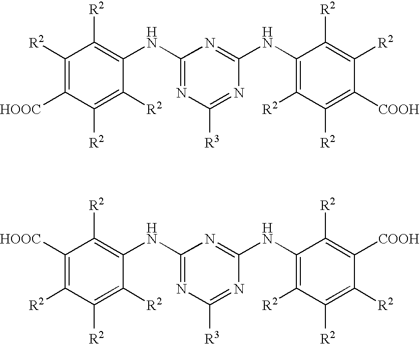
wherein
each R² is independently selected from the group consisting of electron donating groups, electron withdrawing groups, and electron neutral groups, and
R³ is selected from the group consisting of substituted and unsubstituted heteroaromatic rings and substituted and unsubstituted heterocyclic rings, said rings being linked to the triazine group through a nitrogen atom within the ring of R³,
and wherein a counterion is present when required for charge balance;
or zwitterions, proton tautomers, or salts thereof.

18. The method of claim 17 wherein the chromonic material is selected from one or more of the following general formulae: 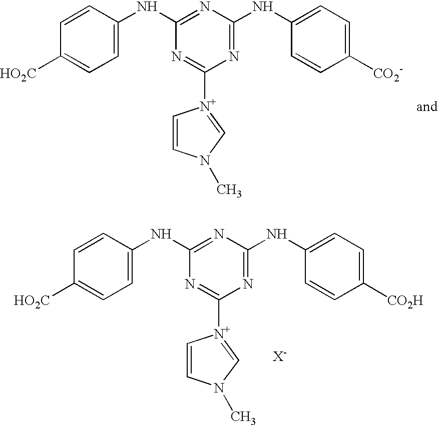
wherein X⁻ is a counterion.

19. The method of claim 17 wherein the chromonic material is 4-({4-[(4-carboxylphenyl)amino]-6-[4-(dimethylamino)pyridinium-1-yl]-1,3,5-triazin-2-yl}amino)benzoate.

20. A multilayered structure comprising:
(a) an ordered nanostructured crosslinked chromonic layer having a pitch between about 100 nm and about 20 μm; and
(b) an ordered nanostructured barrier layer comprising a complex comprising chromonic material, multivalent cations, and acid anions selected from the group consisting of HCO₃⁻, PO₄³⁻, CH₃CHOHCOO⁻, C₃H₅O(COO)₃³⁻, BO₃³⁻, SO₄²⁻, and mixtures thereof disposed on at least a portion of the surface of the ordered nanostructured crosslinked chromonic layer.

21. The structure of claim 20 wherein the ordered nanostructured crosslinked chromonic layer comprises a guest compound.

22. The structure of claim 20 wherein the ordered nanostructured barrier layer further comprises a surface modifying agent.

23. The structure of claim 20 further comprising a second ordered nanostructured chromonic layer having a pitch between about 100 nm and about 20 μm on at least a portion of the ordered nanostructured barrier layer.

24. The structure of claim 23 wherein the second ordered nanostructured chromonic layer comprises a guest compound.

25. The structure of claim 23 wherein the second ordered nanostructured chromonic layer is crosslinked.

26. The structure of claim 20 wherein the acid anion is HCO₃⁻.

27. The structure of claim 20 wherein the acid anion is PO₄³⁻.
